(19) United States
(12) Patent Application Publication
(10) Pub. No.: US 2004/0131328 A1
(43) Pub. Date: Jul. 8, 2004

(54) Method of operating electronic program guide

(76) Inventor: Young-hwan Pan, Suwon-si (KR)

Correspondence Address: Christian C. Michel, Roylance, Abrams, Berdo & Goodman, L.L.P., Suite 600, 1300 19th Street N.W., Washington, DC, 20036, US

(21) Appl. No.: 10/682,798

(22) Filed: Oct. 10, 2003

(30) Foreign Application Priority Data
Jul. 11, 2002 (KR) 2002-68764

(51) Int. Cl. H04N 7/00

(52) U.S. Cl. 386/46

(57) ABSTRACT

A method of operating an electronic program guide (EPG) is provided, by which a user can effectively move along a programming time axis in the EPG using a remote control device. The method includes receiving a signal indicating a desired future or past programming time to enable a user to move to the desired programming time in an EPG after the user has moved to a desired channel and receiving a program selection signal in an EPG after the user has moved to the desired channel and the desired programming time.

### CROSS REFERENCE TO RELATED APPLICATION

This application claims priority from Korean Patent Application No. 2002-68764, filed on 7 Nov. 2002 in the Korean Intellectual Property Office, the disclosure of which is hereby incorporated by reference in its entirety.

### BACKGROUND OF THE INVENTION

1. Field of the Invention

The present invention relates to a TV operating method. More particularly, the present invention relates to a method of operating an electronic program guide (EPG), by which a user can effectively move along a programming channel axis and a programming time axis in the EPG using of a remote control device.

2. Description of the Related Art

Recently, broadcasting stations have started to provide electronic program guides (EPG) to allow TV viewers to find broadcast schedules on TV screens instead of in newspapers. An EPG is a general feature of digital broadcasting and is used in the following manner. In digital broadcasting, an image and a sound stream are compressed into digital information. Also, system information and program information are compressed in accordance with Program and System Information Protocol (PSIP) standards. At this time, program-related information is decoded from data including image information and sound information. Based on the program-related information, the EPG is displayed on a TV screen. A user can access such program information for a maximum of 16 days according to the PSIP standards. In the EPG, such program information is typically provided to the user as a table organized by channels and programming times.

FIGS. 1A and 1B are views for explaining a conventional method of operating an EPG. As shown in FIG. 1A, to provide the user with desired programming time and channel information, the EPG shows the programming times on a horizontal axis and the channels on a vertical axis. In the case of a remote control device including four directional keys, such as, for example, up, down, left, and right keys, a program cell is selecting by moving a highlight to a program cell using the directional keys. When moving on the time axis, the user typically moves 30 minutes at a time using the left and right keys. When moving on the channel axis, the user typically moves by one channel at a time using the up and down keys. If the user selects a channel 512 in the EPG of FIG. 1A and inputs the right key, the EPG shifts by 30 minutes, and is displayed as shown in FIG. 1B.

Typically, the user operates the EPG using four directional keys and a confirm key. Since the highlight moves within the program cell, it is difficult for the EPG to provide the user with a special button for channel and programming time movement. To solve such a problem, some products adopting the EPG use additional keys, such as four color keys for example. In this case, a remote control device includes four additional keys. The user can move along the channel axis by directly inputting the channel number or using the up and down keys. However, a method of effectively moving along a programming time has not yet been introduced.

### SUMMARY OF THE INVENTION

Embodiments of the present invention provide a method of operating an electronic program guide (EPG), by which a user can effectively move to a programming time in the EPG using a remote control device.

According to one aspect of the present invention, there is provided a method of operating an electronic program guide (EPG). The method comprises (a) receiving a signal indicating a desired future or past programming time to enable a user to move to the desired programming time in an EPG after the user has moved to a desired channel and (b) receiving a program selection signal in an EPG after the user has moved to the desired channel and the desired programming time. The desired programming time is moved by a predetermined amount of time and a day. In step (a), the user moves to a past programming time by receiving a signal indicating inputs of the past programming time and a left directional key. In step (a), the user moves to a future programming time by receiving a signal indicating inputs of the future programming time and a right directional key.

### BRIEF DESCRIPTION OF THE DRAWINGS

The above and other aspects and advantages of the present invention will become more apparent with reference to the detailed description of the exemplary embodiments in connection with the attached drawing figures in which:

FIGS. 1A and 1B illustrate a conventional method of operating an electronic program guide (EPG);

FIG. 2 is a block diagram showing an apparatus for operating the EPG according to an embodiment of the present invention;

FIG. 3 is a flowchart showing a method of operating the EPG according to an embodiment of the present invention; and

FIGS. 4A through 4C illustrate the method of operating the EPG shown in FIG. 3.

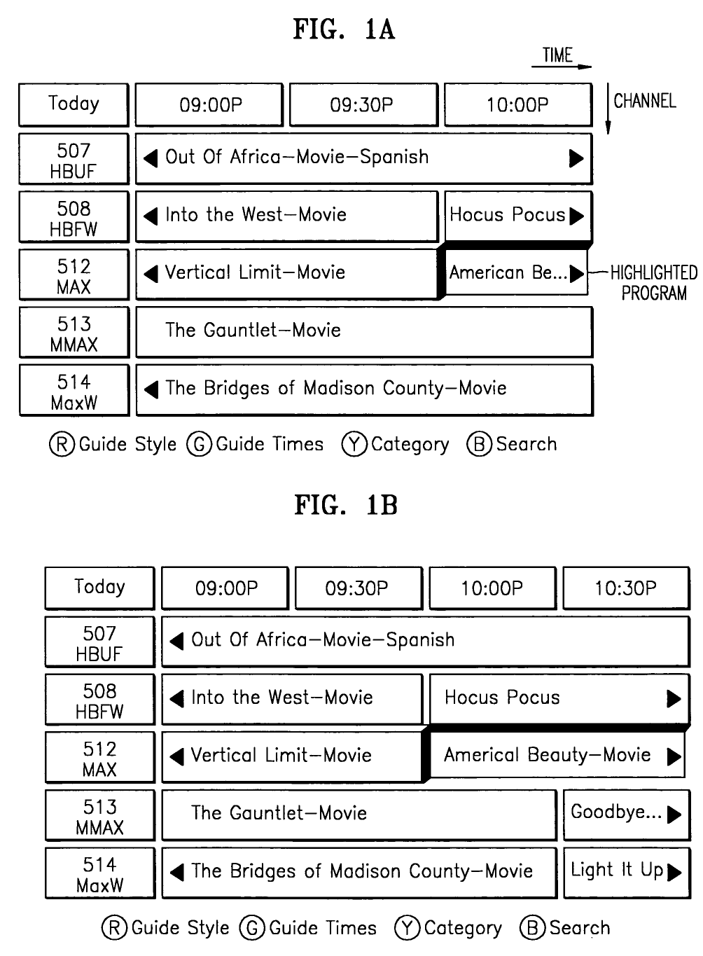

### DETAILED DESCRIPTION OF THE PREFERRED EMBODIMENT

The present invention will now be described more fully with reference to the accompanying drawing figures, in which embodiments of the invention are shown.

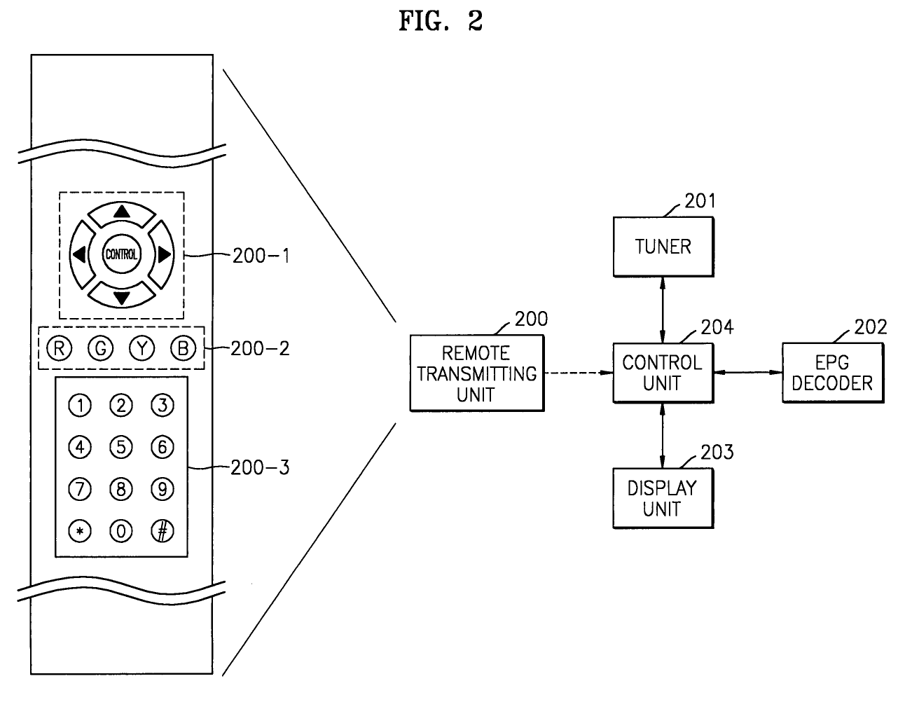

FIG. 2 is a block diagram showing an apparatus for operating an electronic program guide (EPG) according to the present invention. The apparatus for operating the EPG includes a remote transmitting unit 200, a tuner 201, an EPG decoder 202, a display unit 203, and a control unit 204. The user inputs desired information using the remote transmitting unit 200. The tuner 201 tunes broadcast signals received through an antenna (not shown). The EPG decoder 202 decodes additional information signals separated from the signals tuned by the tuner 201. The display unit 203 displays the signals decoded by the EPG decoder 202. The control unit 204 separates the signals tuned by the tuner 201 into an audio signal, a video signal, and an additional information signal according to the desired information received from the remote transmitting unit 200, controls the EPG decoder 202, and outputs a control signal corresponding to data output from the EPG decoder 202. In embodiments of the present invention, the remote transmitting unit 200 includes four directional keys 200-1, color keys 200-2, and number keys 200-3.

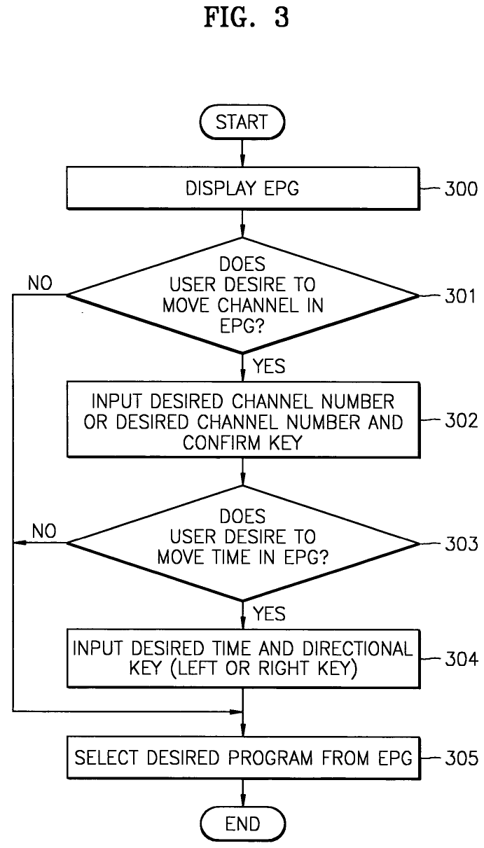

FIG. 3 is a flowchart showing a method of operating the EPG according to the present invention. The method includes step 300 for displaying the EPG, step 301 for determining whether the user desires to move along the channel axis in the EPG, step 302 for inputting a desired channel number or the desired channel number and a confirm key, step 303 for determining whether the user desires to move along a programming time axis in the EPG, step 304 for inputting a desired programming time and the directional key (a left or right key), and step 305 for selecting a program of interest from the EPG.

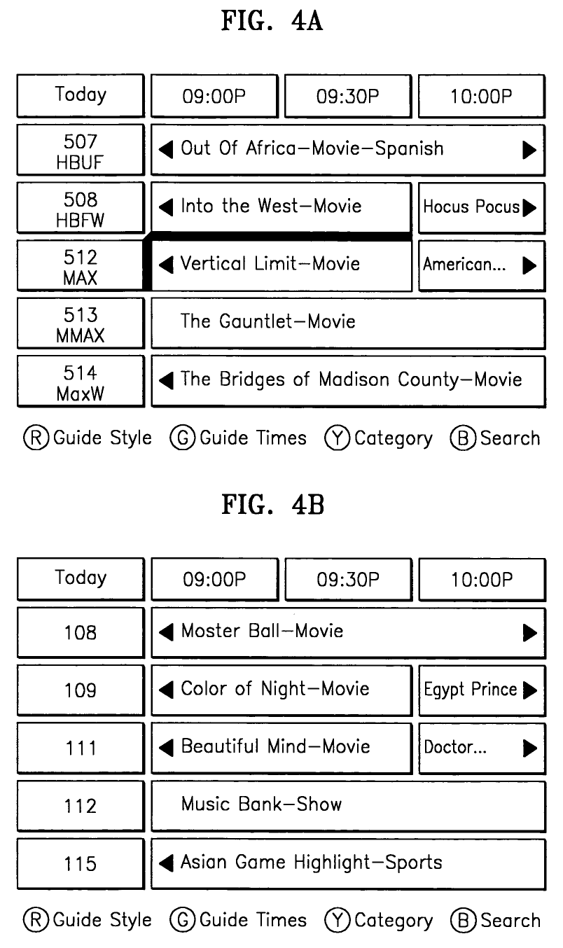

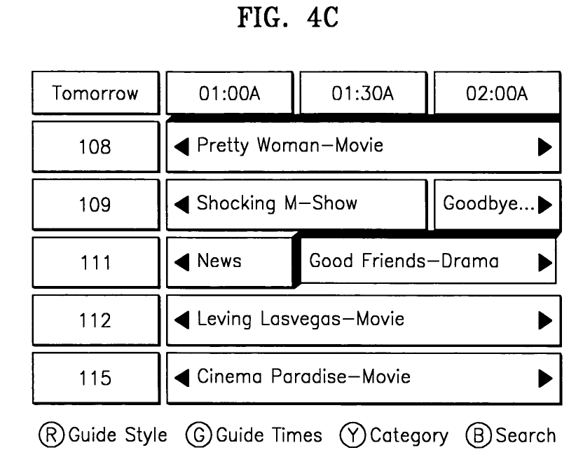

FIGS. 4A through 4C illustrate the method shown in FIG. 3.

Now the present invention will be described in further detail with reference to FIGS. 2 through 4.The user uses the remote transmitting unit 200 to select a desired program from among programs provided by a broadcasting station or an external program provider. The user can select the desired program using the four directional keys 200-1, the color keys 200-2, or the number keys 200-3. Once a program is selected, the remote transmitting unit 200 transmits a signal corresponding to the selected program to the control unit 204.

The control unit 204 receives the signal transmitted from the remote transmitting unit 200 and outputs a control signal for tuning to the program provided by broadcasting stations or external program providers. The tuner 201 tunes the signals of the broadcasting stations or external program providers from among the broadcasting signals received through the antenna (not shown) and outputs the tuned signals to the control unit 204. The control unit 204 separates the tuned signals into an audio signal, a video signal, and an additional information signal. The EPG decoder 202 decodes the additional information signal and outputs the result as EPG information.

Then, an additional signal processor (not shown) processes the audio signal and the video signal. The display unit 203 displays the audio signal and the video signal when the user selects the program.

After the user inputs a command for sending the EPG information to the remote transmitting unit 200, the control unit 204 outputs the EPG information decoded by the EPG decoder 202 to the display unit 203 in response to the input command. FIGS. 4A, 4B, and 4C illustrate the EPG information output to the display unit 203.

FIG. 4A shows the EPG information displayed by the display unit 203. As shown in FIG. 4A, the EPG information includes programming times on a horizontal axis and channels on a vertical axis so as to allow the user to obtain a desired programming time and desired channel information by manipulating the remote transmitting unit 200. In FIG. 4A, the user highlights a program “Vertical Limit” on a channel 512.

To move along the channel axis, the user inputs a desired channel number shown in the EPG using the number keys 200-3. FIG. 4B shows the EPG for explaining the channel movement. When the user inputs “108” using the number keys 200-3 to move to a channel 108, the EPG of FIG. 4A changes into the EPG as shown in FIG. 4B after a predetermined amount of time has passed. Also, when the user inputs “108” to move to the channel 108 using the number keys 200-3 and inputs the confirm key, the EPG of FIG. 4A changes into the EPG as shown in FIG. 4B after the predetermined amount of time has passed. After the channel 108 is displayed, next channels 109 111,112, and 115 are sequentially displayed.

The user inputs a desired programming time and the directional keys 200-1 to obtain programming time information of the channel including the highlighted program. The control unit 204 receives the signal transmitted from the remote transmitting unit 200 and determines whether the user moves the channel or the programming time based on the user input of the directional keys 200-1. When the user desires to move to a past programming time, the user inputs the desired programming time and a left key. When the user desires to move to a future programming time, the user inputs the desired programming time and a right key. Then, the EPG shifts to the past programming time (the left) or the future programming time (the right). The user can set an amount of time and a day by which the programming time is moved. If the user has not set the amount of time and the day, the control unit 204 preferably sets them by default.

FIG. 4C shows the EPG after the user moves to the future programming time, such as four hours later from the current time for example. After the user inputs “4” using the number keys 200-3 and the right key in the EPG of FIG. 4B, the EPG as shown in FIG. 4B changes into the EPG of FIG. 4C. At this time, it is assumed that the amount of time by which the programming time is moved has been set at multiples of one hour.

Hereinafter, a method of operating the EPG will be described with reference to FIG. 3. In the first step 300, once the user selects the EPG through the remote transmitting unit 200, the control unit 204 outputs the EPG information to the display unit 203 in response to the user input. Such EPG information is shown in FIG. 4A. In FIG. 4A, the program on the channel 512 is highlighted.

In steps 301 and 302, when the user desires to move to a new channel in the EPG, the user inputs the desired channel number or the desired channel number and the confirm key using the remote transmitting unit 200. If a predetermined amount of time, e.g., 3 seconds, has passed after the user input, the control unit 204 receives the user input and outputs the EPG information corresponding to the user input to the display unit 203. At this time, the desired channel is highlighted. The user can highlight a program of interest from the EPG information displayed in the display unit 203.

In steps 303 and 304, when the user desires to move to a new programming time in the EPG, the user inputs the desired programming time and the directional key, i.e., the left or right key. If the user desires to move to a past programming time, the user inputs the desired programming time and the left key. If the user desires to move the future programming time, the user inputs the desired programming time and the right key. Then, the highlight moves to a past programming time (the left) or to a future programming time (the right). The user can set an amount of time and a day by which the programming time is moved. If the user has not set the amount of time and the day, the control unit 204 preferably sets them by default. FIG. 4C shows the EPG after the user moves to the future programming time, such as four hours later from the current time for example. After the user inputs “4” using the number keys 200-3 and the right key in the EPG of FIG. 4B, the EPG of FIG. 4B changes into the EPG as shown in FIG. 4C. At this time, it is assumed that the amount of time by which the programming time is moved has been set at multiples of one hour.

After the user moves to the desired channel and programming time, the user selects the program of interest based on the displayed EPG information, in step 305.

As described above, the user can effectively move to a programming time in the EPG using the remote control device.

In addition, it should be understood that the above described method can be embodied in a computer readable medium of instructions to be executed by a microprocessor and the like.

While the present invention has been particularly shown and described with reference to exemplary embodiments thereof, it will be understood by those of ordinary skill in the art that various changes in form and details may be made therein without departing from the spirit and scope of the invention as defined by the appended claims and their equivalents.

What is claimed is:

1. A method of operating an electronic program guide (EPG), the method comprising:
(a) receiving a signal indicating a desired future or past programming time to enable a user to move to the desired programming time in an EPG after the user has moved to a desired channel; and
(b) receiving a program selection signal in an EPG after the user has moved to the desired channel and the desired programming time.

2. The method of claim 1, wherein the desired programming time is moved by a predetermined amount of time and a day.

3. The method of claim 1, wherein, in step (a), the user moves to a past programming time by receiving a signal indicating inputs of the past programming time and a left directional key.

4. The method of claim 1, wherein, in step (a), the user moves to a future programming time by receiving a signal indicating inputs of the future programming time and a right directional key.

5. A computer readable medium of instructions for controlling a device to operate an electronic program guide (EPG) comprising:
a first set of instructions adapted to control the device to receive a signal indicating a desired future or past programming time to enable a user to move to the desired programming time in an EPG after the user has moved to a desired channel; and
a second set of instructions adapted to control the device to receive a program selection signal in an EPG after the user has moved to the desired channel and the desired programming time.

6. The computer readable medium of instructions of claim 5, wherein the desired programming time is moved by a predetermined amount of time and a day.

7. The computer readable medium of instructions of claim 5, wherein the first set of instructions is further adapted to control the device to move to a past programming time by receiving a signal indicating inputs of the past programming time and a left directional key.

8. The computer readable medium of instructions of claim 5, wherein the first set of instructions is further adapted to control the device to move to a future programming time by receiving a signal indicating inputs of the future programming time and a right directional key.
